(19) United States
(12) Patent Application Publication
(10) Pub. No.: US 2025/0227825 A1
(43) Pub. Date: Jul. 10, 2025

(54) TOROIDAL PROCESSING CHAMBER

(71) Applicants: THE UNIVERSITY OF NOTTINGHAM, NOTTINGHAM (GB); MORTIMER TECHNOLOGY HOLDINGS LIMITED, THATCHAM (GB)

(72) Inventors: Samuel KINGMAN, Nottingham (GB); Christopher DODDS, Nottingham (GB); Jose RODRIGUEZ, Nottingham (GB); Christopher Edward DODSON, Thatcham (GB)

(21) Appl. No.: 18/702,700

(22) PCT Filed: Oct. 14, 2022
(86) PCT No.: PCT/GB2022/052624

§ 371 Date: Apr. 18, 2024

(30) Foreign Application Priority Data
Oct. 19, 2021 (GB) 2114895.2

(51) Int. Cl. H05B 6/80; B01J 2/16; B01J 8/38; H05B 1/02; H05B 6/64; H05B 6/70

(52) U.S. Cl. CPC H05B 6/806; B01J 2/16; B01J 8/38; H05B 1/0244; H05B 6/6402; H05B 6/708; H05B 6/802

(57) ABSTRACT

An apparatus for processing a material is disclosed. The apparatus comprises a toroidal bed chamber (110) and a waveguide (120). The toroidal bed chamber (110) has chamber walls comprising an inner sidewall (111), an outer sidewall (112) and a base (113), the inner sidewall (111), outer sidewall (112) and base (113) at least partly defining a toroidal volume for material to circulate within. A circulation fluid inlet (130) is provided for introducing a circulation fluid (131) with a velocity component tangential to the toroidal volume for causing the material to circulate within the toroidal volume. The waveguide (120) is for receiving microwave radiation and communicating the microwave radiation to interior of the toroidal bed chamber. The waveguide (120) comprises at least one microwave transparent window (121) in the inner sidewall (111), the outer sidewall (112) or the base (113).

### FIELD OF THE INVENTION

The present invention relates to an apparatus and a method for processing material in a toroidal bed chamber, more specifically to an apparatus and method for processing material contained in a toroidal bed using microwave radiation.

### BACKGROUND

Toroidal bed (TORBED) chambers are used in industry for the processing of material, in particular material pellets and particulate material. Toroidal bed chambers and their methods of use are well established and used for the processing of a wide range of materials, including foodstuffs, organic materials, minerals and chemical products.

During the processing, a circulation fluid such as air is introduced into the chamber with a vertical and tangential velocity component. When the material is added to the chamber, the tangential component of the velocity of the circulation fluid causes the material to circulate around the chamber, while the vertical component lifts the material up from the base of the chamber. The result in some examples is a fluidised bed of material. In some examples the material may be continuously mixed by the turbulence of the fluidised bed. In other examples the material may circulate in a more laminar fashion.

It is well known that the circulation fluid can be a heated gas. As the heated gas passes through the material bed, heat is transferred to the material. Processing of materials in a toroidal bed chamber can therefore provide an effective method of simultaneously heating and mixing/agitating materials.

There is interest in developing a toroidal bed chamber that is coupled to a microwave radiation source, and methods for processing material as such. Such a system may be called a hybrid microwave—toroidal bed chamber, and has the potential to allow for hybrid heating from microwave radiation and circulation and mixing that is inherent to TORBED chambers.

In the prior art, there have been recent attempts at developing such apparatuses and methods. A microwave radiation source coupled to a toroidal bed chamber for the purpose of hybrid heating, as well as accompanying methods, is described in patent application WO/2019/145735A1.

The systems developed so far are limited in the efficiency of transfer of microwave radiation into the chamber. It is difficult to efficiently couple the microwave radiation with the material in the chamber, and to do so in a way that enables predictable and controllable heating of the material.

Furthermore, the means of coupling the radiation source to the chamber may interfere with introducing and removing material to and from the chamber.

Although existing hybrid microwave—toroidal bed chambers are promising for the processing of materials, there remains considerable room for improvement to the state of the art in order to make them commercially exploitable.

### SUMMARY

According to a first aspect of the invention, there is provided an apparatus for processing of a material in a hybrid microwave—toroidal bed chamber, the apparatus comprising:
a toroidal bed chamber, comprising:
   chamber walls comprising an inner sidewall, an outer sidewall and a base, the inner sidewall, outer sidewall and base at least partly defining a toroidal volume for the material to circulate within;
   a circulation fluid inlet for introducing a circulation fluid with a velocity component tangential to the toroidal volume for causing the material to circulate within the toroidal volume.

The apparatus further comprises a waveguide for receiving microwave radiation and communicating the microwave radiation to the interior of the toroidal bed chamber, the waveguide comprising at least one microwave transparent window in the inner sidewall, the outer sidewall or the base.

Coupling a microwave radiation source to a conventional toroidal bed chamber can result in a number of advantages, including: application of lower circulation fluid (e.g. air) temperatures; reduced surface over-heating of the material; application to temperature sensitive products; shorter processing times due to higher efficiency heating; better controlled processing due to instant control of the heating profile by modifying the microwave power. The advantages have been hitherto not been realised, but may be realised in embodiments.

By communicating the microwave radiation into the chamber through a window in the inner side wall, the outer sidewall or the base, an advantage is obtained over an arrangement in which microwave radiation enters the chamber from above the bed. Many materials become less dense as they are processed (for example water may be expelled from the material, or individual pellets/particulates of the material may inflate or puff up), causing processed material to rise to the top of the chamber. Alternatively, by-products (for example steam or volatile organic compounds) may be released by the material as it is processed, which may also rise to the top of the chamber. In apparatuses of the prior art, these processed materials and by-products absorb some of the microwave radiation as it enters from the top of the chamber. The apparatus of the present invention reduces the amount of undesirable absorption of microwave radiation by such processed material and by-products, increasing the efficiency of microwave energy transfer to the bed of unprocessed material at the base of the chamber.

The waveguide may comprise a vertical portion wherein the vertical portion extends upwards towards the microwave transparent window from below the toroidal bed chamber.

The vertical portion of the waveguide allows for microwave radiation to be supplied to chamber from below the chamber. This provides an advantage over the prior art as the waveguide and a microwave radiation source may now be situated below the chamber where they do not interfere with access to the chamber and material inlets or outlets.

The waveguide may comprise a waveguide ring that is situated adjacent to the inner sidewall, the outer sidewall or base of the chamber.

The waveguide ring may comprise at least one slot for communicating the microwave radiation to the chamber.

The waveguide ring may comprise a plurality of slots or openings that are evenly spaced around the waveguide ring.

The slots of the waveguide ring may be configured so that the microwave radiation carried to the chamber via the slots from the waveguide drives a multimodal electromagnetic field within the chamber (i.e. more than one mode of the chamber is driven by the microwaves entering the chamber via the slots—these modes combine to provide a defined resonant field pattern in the chamber).

By using a slotted waveguide ring to communicate microwave radiation to the chamber, a controlled and defined electromagnetic field can be established in the chamber. This is in comparison to the prior art which uses a straight waveguide or else situates the radiation source in the chamber, which would generate an uncontrolled multimodal field.

The uncontrolled multimodal field would result in an unpredictable distribution of microwave energy in the chamber, which may result in undesirable hot spots that heat the material unevenly and with little control. For example, regions of high electromagnetic field could arise at the outer edge of the toroidal bed where already processed material may accumulate, resulting in inefficient microwave transfer to unprocessed material. Alternatively, poor efficiency could occur as energy is stored or concentrated in the upper part of the toroidal chamber outside of the material bed. Again, this will reduce the efficiency of microwave transfer and waste energy. The uncontrolled fields of the prior art do not allow for these undesirable effects to be mitigated effectively.

By contrast, the controlled multimodal field generated by the slotted waveguide ring results in a well distributed standing wave type field, with multiple regions of high field density distributed around the circumference of the chamber in the region of the material circulating in the toroidal bed. This improves the distribution of heating of the material and ensures that all material within the bed receives sufficient microwave energy, which is particularly advantageous for materials with short processing times.

The toroidal bed chamber may comprise at least one inlet for introducing the material into the chamber.

The inlet for introducing the material into the chamber may comprise at least one of:
i) a powder injector configured to entrain powder in the circulation fluid before the circulation fluid inlet;
ii) a side feeder configured to introduce material via an opening in the outer sidewall of the toroidal bed chamber;
iii) a top feeder configured to introduce material from the top of the toroidal bed chamber.

The side feeder may comprise a screw auger. The top feeder may comprise a screw auger.

The top feeder may be configured to discharge material in a central region of the toroidal bed chamber. The top feed may be co-axial with the toroidal bed chamber. The top feeder may be configured to discharge material on the inner sidewall.

The toroidal bed chamber may comprise at least one outlet for removing the material from the chamber.

The outlet for removing the material from the chamber may comprise at least one of:
i) a bed diverter discharger configured to divert a continuous flow of the circulating material to exit the toroidal bed chamber;
ii) a lifting chamber discharger configured to open a circumferential gap in the outer sidewall of the toroidal bed chamber so that circulating material escapes the chamber under centrifugal force;
iii) a side discharger configured to discharge circulating material through the outer sidewall;
iv) a dump door arranged in the outer sidewall
v) a pneumatic or vacuum extractor configured to remove material from the chamber using suction.

The bed diverter discharger may comprise a diverter that diverts the flow of the circulating material towards a longitudinal axis of the toroidal bed chamber.

The lifting chamber discharger may be operable to lift the outer sidewall to create the circumferential gap.

The side discharger may be operable to discharge circulating material that is entrained in a flow of gas exiting the toroidal bed chamber via the side discharger. The side discharger may comprise a flow controller (such as a valve) to control the flow of gas (and entrained material) through the side discharger.

The side discharger may comprise a diverter operable to divert a flow of the circulating material to exit the toroidal bed chamber through the outer sidewall. The side discharger may comprise an actuator configured to move the side discharger diverter into and out of the flow of circulating material.

The type of the material inlet and material outlet may be chosen from a range of inlets and outlets to suit the needs of the material being processed.

The apparatus may comprise a microwave radiation source, wherein the microwave radiation source is coupled to the waveguide.

The circulation fluid may be a gas.

The apparatus may comprise a device for heating or cooling the circulation fluid by which means thermal energy can be transferred to or from the material in the bed as the circulation fluid passes through it. This enables the bed to be circulated (mixing the material via turbulence in the bed) and heated or cooled inside the chamber.

The apparatus may comprise a fan or impellor for accelerating the circulation fluid. The circulation fluid may be accelerated to sufficient speed so that on leaving the circulation fluid inlet a fluidised bed of material can be produced and the bed can circulate around the chamber at sufficient speed.

The apparatus may comprise a circulation fluid loop that fluidly couples a circulation fluid exhaust of the chamber to the fan or impellor. This enables exhaust circulation fluid that has passed through the chamber to be driven back into the chamber.

According to a second aspect of the invention, there is provided a method for processing the material in the hybrid microwave—toroidal bed chamber apparatus. The processing method comprises:
circulating material within a toroidal chamber using a flow of fluid with a velocity component tangential to a toroidal chamber;
heating the material as it circulates within the toroidal chamber by introducing microwaves to the toroidal chamber through a microwave transparent window in an inner sidewall, outer sidewall or base of chamber walls that define toroidal chamber.

The method may comprise:
introducing material into the chamber via a material inlet; and
at a time after introducing material, removing material from the chamber via a material outlet.

The time between the material being introduced to the chamber and later removed from the chamber will depend on the material being processed and the operation of the apparatus (for example the microwave radiation power and circulation fluid temperature).

The method may comprise:
heating or cooling the fluid prior to the fluid circulating the material in the chamber;
heating or cooling the material as it circulates by transferring heat from the heated fluid to the material or from the material to the cooled fluid.

The method may comprise:
controlling the heating or cooling of the fluid and the introduction of microwaves to the chamber to regulate the heating of the material.

By heating the circulation fluid that passes through the bed of material, TORBED apparatuses can heat material by transferring heat from the fluid to the material. In a hybrid microwave—toroidal bed chamber the heating effects of the microwave radiation and the heated circulation fluid may both be varied in order to control the overall heating of the material.

By cooling the circulation fluid that passes through the bed of material, hybrid microwave—toroidal bed chambers can prevent overheating or bulk thermal degradation of the material.

The optional features of the first aspect are applicable to the second aspect. The method may be performed using the apparatus of the first aspect, including any optional features thereof. The method of the second aspect may include any of the features of the example embodiments.

In accordance with the first aspect of the invention, the fluid used to circulate the material may be a gas and may be heated. This allows for both conventional toroidal bed heating and microwave heating of the material in the chamber.

### DETAILED DESCRIPTION

Embodiments of the invention will be described, purely by way of example, with reference to the accompanying drawings, in which:

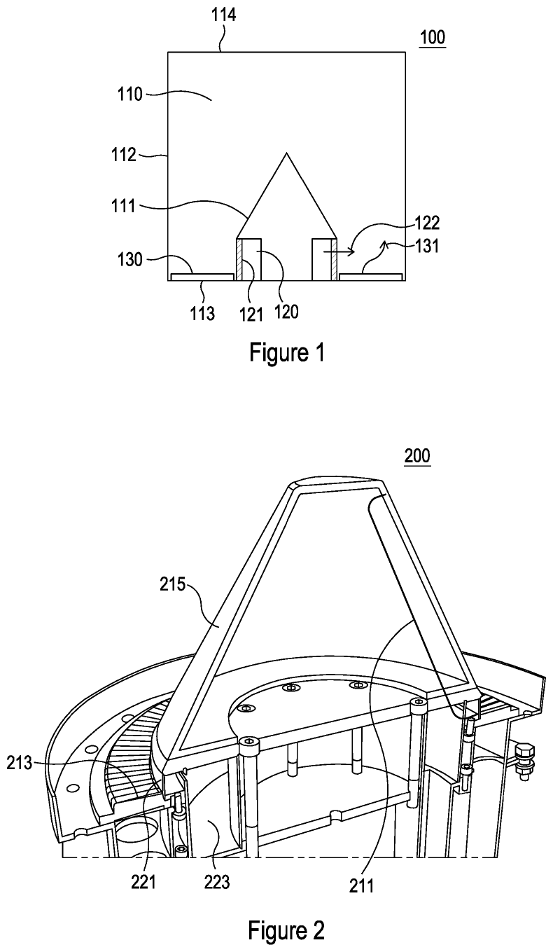

FIG. 1 shows a diagram of a vertical cross-section through an apparatus for hybrid microwave—toroidal bed processing according to an embodiment of the present invention;

FIG. 2 shows a three-dimensional illustration of another example embodiment of the apparatus;

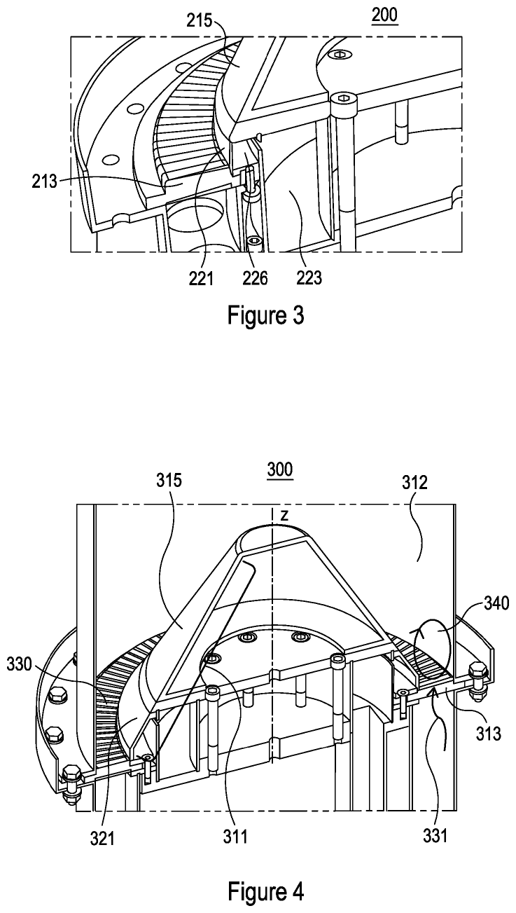

FIG. 3 shows a close-up view of the toroidal bed chamber of FIG. 2;

FIG. 4 shows a three-dimensional illustration of an alternative embodiment of the apparatus;

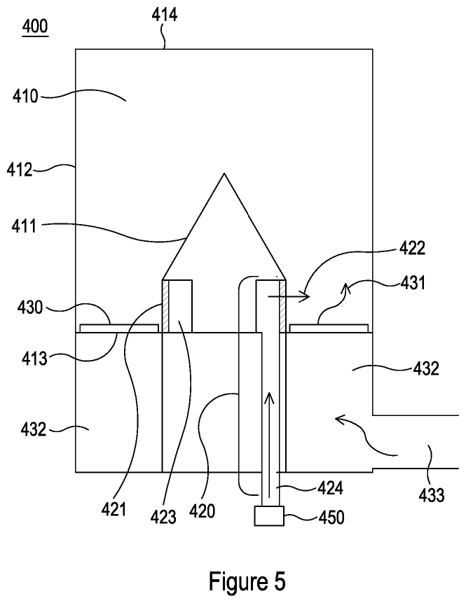

FIG. 5 shows a diagram of a vertical cross-section through an example embodiment of the apparatus, illustrating the coupling of the chamber to a microwave radiation source;

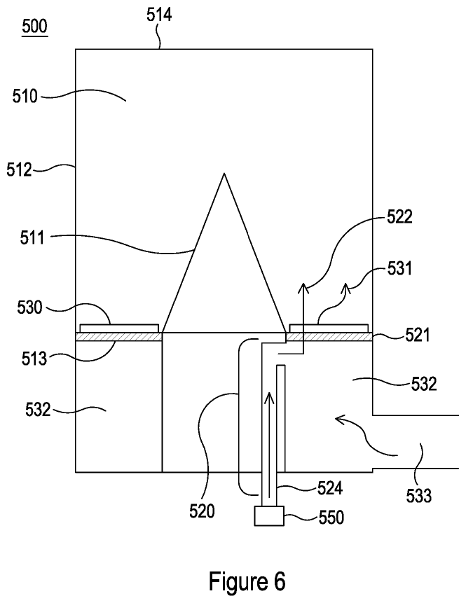

FIG. 6 shows a diagram of a vertical cross-section through an alternative embodiment of an apparatus where a toroidal bed chamber is coupled to a microwave radiation source;

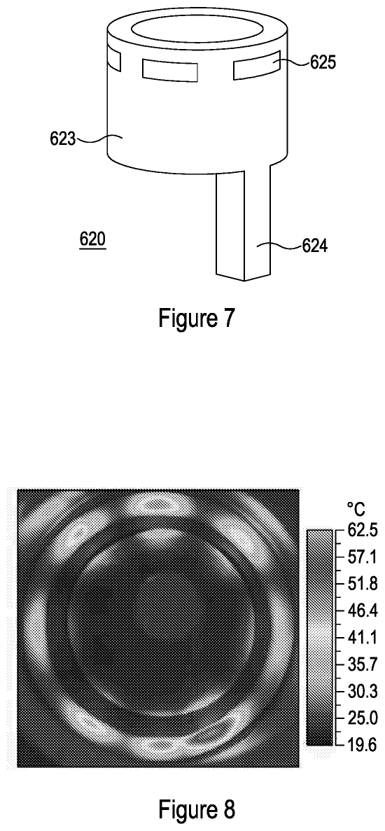

FIG. 7 shows in more detail an embodiment of the waveguide that may be used in an embodiment of the apparatus;

FIG. 8 shows a thermal image illustrating the distribution of microwave energy within the toroidal bed chamber according to an embodiment of the present invention;

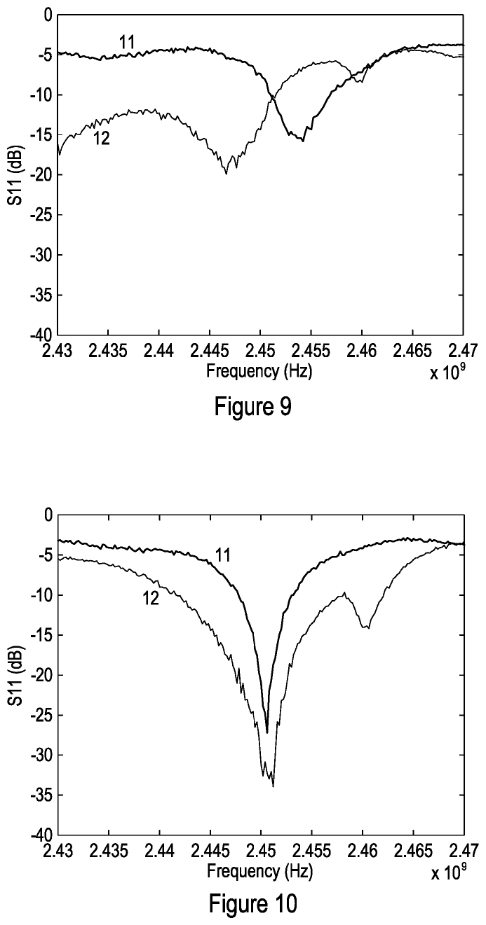

FIG. 9 shows a graph of the S₁₁ reflection coefficient for two embodiments of the invention when the apparatus is untuned;

FIG. 10 shows the S₁₁ reflection coefficient for two embodiments as in FIG. 9, but with the apparatus tuned;

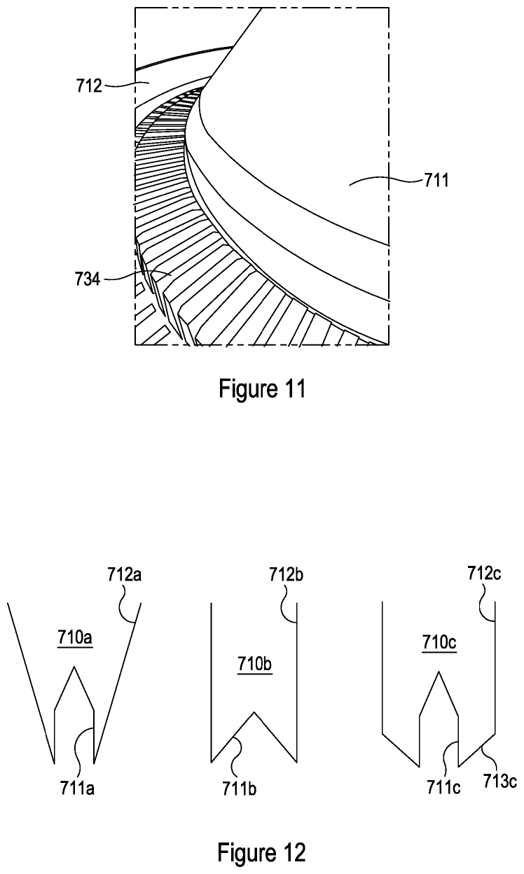

FIG. 11 shows an example of the circulation fluid inlet that may be used in an embodiment of the apparatus;

FIG. 12 shows three example embodiments of the chamber walls that may form the toroidal bed chamber;

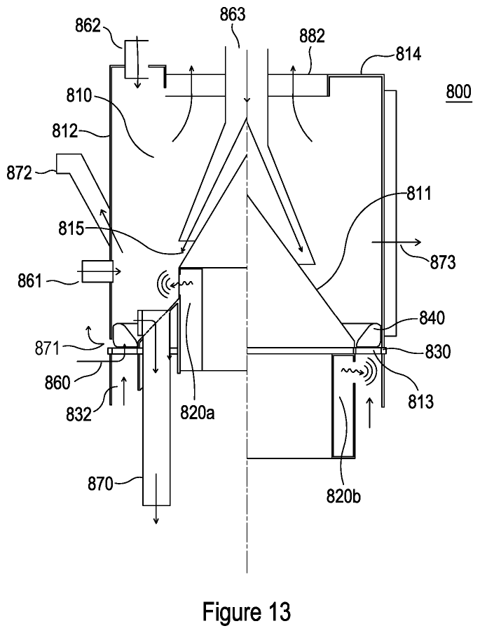

FIG. 13 shows variations of material inlets and material outlets that may be used according to an embodiment of the present invention; and

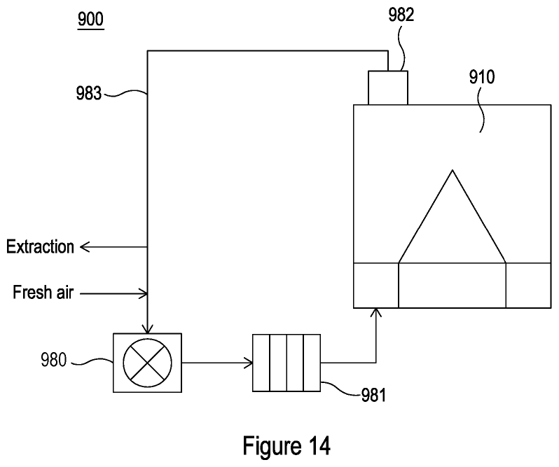

FIG. 14 is a schematic diagram of additional components involved in the generation and treatment of the circulation fluid that that may form an embodiment of the apparatus.

Referring to FIG. 1, an example apparatus 100 is shown for processing of a material, comprising a toroidal bed chamber 110 and a waveguide 120.

The toroidal bed chamber 110 in the example comprises an inner sidewall 111, an outer sidewall 112 and a base 113. The chamber 110 in the example further comprises a ceiling 114 so that the toroidal bed chamber 110 is fully enclosed. In some embodiments the ceiling 114 may instead be a removable or openable lid that is configured to attach to the apparatus.

The chamber 110 further comprises a circulation fluid inlet 130 for introducing circulation fluid 131 to the chamber 110. In the example the circulation fluid inlet 130 is situated on the base of the chamber 113. Details of the inlet are discussed in more detail later.

The apparatus 100 further comprises a waveguide 120. The waveguide 120 comprises a microwave transparent window 121. The waveguide 120 and window 121 allow for microwave radiation 122 to be communicated to material within the chamber 110. The waveguide 120 receives microwave radiation from a microwave radiation source (not pictured) that is coupled to the waveguide. In this example the window 121 forms part of the inner sidewall 111.

FIG. 2 shows another example embodiment of the apparatus 200, similar to that shown in schematic form in FIG. 1. In FIG. 2 the waveguide comprises a waveguide ring 223 that is situated within the inner sidewall 211 and which follows the circular shape of the interior surface of the inner sidewall 211. The microwave transparent window 221 in this example is a ring that surrounds a portion of the waveguide ring 223, forming a vertical flat surface through which microwave radiation is communicated to the chamber immediately above the base of the chamber 213. In some embodiments the microwave transparent ring may comprise one or more circumferential windows or slots distributed (e.g. evenly spaced) about the inner sidewall 211. There may, for example, be at least 6 windows spaced about the circumference of the inner sidewall 211.

In this example, window 221 is in the inner sidewall 211. The sidewall comprises a frustoconical surface 215 (angled portion) and a cylindrical (vertical portion) surface comprising the window 221. In this example the entire vertical portion of the inner sidewall 211 comprises window 221, but in other embodiments the window 221 may comprise only part of the cylindrical sidewall.

FIG. 3 shows a magnified view of the apparatus 200 of FIG. 2. As in FIG. 2, the waveguide ring is situated inside the inner sidewall, the inner sidewall comprising a frustoconical portion 215 and a cylindrical portion comprising a microwave transparent window 221 for communicating microwave radiation to the chamber immediately above the base 213.

The waveguide may further comprise a spacing region 226 that separates the outer surface of the waveguide ring 223 from the internal surface of the window 221.

FIG. 4 shows an alternative embodiment of the apparatus 300 according to the present invention, wherein the microwave transparent window 321 is disposed in an inner sidewall 311. The microwave transparent window 321 comprises a frustoconical upper portion and a cylindrical lower portion. The inner sidewall 311 comprises a frustoconical surface comprising the frustoconical upper portion of the microwave transparent window 321 and a further frustoconical portion 315 that is not transparent to microwaves.

A toroidal volume 340 may be defined by the inner sidewall 311, the outer sidewall 312 and the base of the chamber 313. The toroidal volume 340 is the area of the chamber that contains the bed of material when the apparatus is in operation. The toroidal volume 340 is indicated in FIG. 4. It will be understood that the examples of FIGS. 1 and 2 comprise a similar toroidal volume (not labelled).

In the example embodiment of FIG. 4, there is a plurality of circulation fluid inlets 330 situated on the base of the chamber 313. In some of the embodiments, the fluid inlets 330 may comprise the entire chamber base 313, as illustrated in FIG. 4. In other embodiments, the fluid inlets 330 may be discrete components situated on the chamber base 313 or otherwise elsewhere in the chamber.

The circulation fluid 331 that is introduced to the chamber via the circulation fluid inlets 330 may have a vertical component and a tangential component to its velocity. Referring to FIG. 4, the vertical velocity component of the circulation fluid will lift a bed of material (not pictured) contained in the toroidal volume 340 up from the base 313 and away from the circulation fluid inlets 330. The tangential component of the circulation fluid's velocity will cause the material bed contained in the toroidal volume 340 to circulate around the z axis of the chamber. A combination of centrifugal force experienced by the material as it circulates, and turbulence created by the circulation fluid will cause mixing of the material bed contained in the toroidal volume 340 (in some embodiments, by fluidisation, but this is not essential).

The vertical window 221 of FIG. 2 may be easier and more cost effective to fabricate than the conical window 321 shown in FIG. 4.

According to some embodiments of the invention, the microwave transparent window may comprise or consist of PTFE. In other embodiments of the invention, the window may comprise or consist of a ceramic material capable of withstanding higher temperature applications of the apparatus (above 230° C.). In some embodiments the microwave transparent window may be an opening in the inner sidewall, outer sidewall or base. Where this is the case, a flow of gas through the microwave transparent window may prevent egress of material out of the chamber through the openings forming the microwave transparent window.

FIG. 5 shows a schematic sectional diagram of an apparatus 400 like that of FIG. 1. As in FIG. 1, the chamber 410 comprises an inner sidewall 411, outer sidewall 412, base 413 and ceiling 414. Circulation fluid inlets 430 are again situated on the base 413 for introducing circulation fluid 431 to the chamber 110. According to an embodiment, the circulation fluid may be flowed into the circulation fluid inlets 430 via a toroidal plenum 432 that is situated below the base 413 and fluidly coupled to the circulation fluid inlets 430. The circulation fluid 431 may be a heated or cooled gas that is supplied to the plenum 432 by a circulation fluid supply pipe 433.

The microwave waveguide 420 comprises a toroidal waveguide portion 423 and a microwave transparent window 421 for communicating microwave radiation 422 to the chamber 410. The waveguide 420 further comprises a vertical portion 424. The vertical waveguide portion 424 is situated below the base of the chamber 413 and passes up through the hole at the centre of the toroidal plenum 432. The vertical portion of the waveguide 424 is coupled to a microwave radiation source 450.

FIG. 6 shows an apparatus 500 according to an alternative embodiment. The chamber 510 comprises an inner sidewall 511, an outer sidewall 512, a base 513 and a ceiling 514. Circulation fluid inlets 530 are situated on the base 513 for introducing circulation fluid to the chamber 510. The circulation fluid inlets 530 are fluidly coupled to a toroidal plenum 532 that is situated below the base 513. Circulation fluid 531 may be supplied to the plenum 532 by a circulation fluid supply pipe 533.

In this embodiment the waveguide 520 comprises a vertical portion 524 that is situated below the base 513 and passes up through the hole at the centre of the toroidal plenum 532. The vertical portion 524 is coupled to a microwave radiation source 550. In this embodiment the waveguide is configured to direct the microwave radiation 522 into the chamber 510 through the base 513 of the chamber. The waveguide 520 comprises a microwave transparent window 521 in the base of the chamber 513. At least part of (and in some embodiments, all of) the base of the chamber 513 may comprise microwave transparent window 521. The circulation fluid inlets 530 may be configured to be transparent to microwave radiation.

The toroidal plenum 432, 532 may incorporate a mesh, made from a material such as aluminium, situated below the circulation fluid inlet 430, 530 to contain the microwave radiation within the chamber.

According to some embodiments of the invention, measures may be taken to limit the microwave radiation leakage from the chamber. This may include sealing around the circulation fluid inlets, chamber walls, waveguide and other components using metallic tape or welding, eliminating gaps in the chamber and thus reducing microwave leakage.

In a further embodiment of the present invention, the waveguide may be situated on the exterior of the chamber, and a microwave transparent window may be disposed in the outer sidewall of the chamber. The waveguide may comprise a ring (or toroidal portion) that is placed around the exterior of the chamber. The waveguide may comprise a vertical portion that is situated below the base but outside of the toroidal plenum. This embodiment is analogous to the apparatus shown in FIG. 5 but with the waveguide and microwave transparent window situated on the exterior of the apparatus.

Having the waveguide and microwave transparent window on the interior of apparatus, as depicted in FIGS. 5 and 6 may be advantageous. If situated on the exterior of the apparatus, the size of the apparatus will be increased, and the waveguide may interfere with material inlets and outlets. Furthermore, the centrifugal force of the circulating material bed may cause the material to impact the outer sidewall. If the microwave transparent window is situated in the outer sidewall this may increase maintenance requirements compared to embodiments where the window is situated in the inner sidewall or base where material is being directed away from the window (by centrifugal force and/or the circulation fluid).

FIG. 7 shows a waveguide 620 that may be used to communicate microwave radiation to the chamber of an apparatus (for example, like those shown in FIGS. 1 to 6). In some embodiments the waveguide 620 may comprise a toroidal waveguide portion 623 that comprises at least one slot 625. The example waveguide 620 further comprises a vertical portion 624.

As shown in FIG. 7, in some embodiments, the waveguide may comprise a plurality of slots 625 that are evenly spaced around the waveguide ring 623. According to an embodiment of the invention there may be 8 slots 625 evenly spaced around the waveguide ring 623. Fewer slots may also be used, for example 6 or 4. Using at least 6 slots may be advantageous in improving the efficiency of coupling of microwaves from the waveguide with material in the chamber. In other embodiments, the slots 625 may be unevenly spaced around the ring 623.

Not shown in FIG. 6 is the microwave transparent window. The waveguide guides radiation from the slots into the chamber via the window. The microwave transparent window prevents material from the chamber entering the microwave waveguide 620 where it may be difficult to remove.

In some embodiments of the invention, the slots in the waveguide ring may be configured so that the microwave radiation forms a controlled multimodal electromagnetic field within the chamber. FIG. 8 shows a thermal image of a cross section through the toroidal bed chamber, taken on a horizontal plane where the microwave radiation is communicated from the slots of the waveguide shown in FIG. 7 to the toroidal bed volume within the chamber.

The thermal image of FIG. 8 illustrates the distribution of microwave energy being communicated to the chamber for an example embodiment with 8 slots in the waveguide. It is clear from FIG. 8 that the configuration of the slots of the waveguide results in multiple areas of high microwave energy that are well distributed around the circumference of the toroidal bed chamber. In other embodiments of the invention, the number or distribution of slots of the waveguide ring may be configured to generate a different field distribution—i.e. a different number and distribution of areas of high microwave energy.

The controlled multimodal electromagnetic field generated in this embodiment of the invention may provide an advantage for the processing of certain materials. FIG. 8 illustrates that the slotted waveguide ring of this embodiment is configured to distribute the electromagnetic radiation to multiple areas of the toroidal bed chamber and that this distribution is predictable and spread over a large volume occupied by the bed. This is in contrast to an uncontrolled coupling of the microwave radiation to the chamber, which may create unpredictable, unevenly distributed hot spots within the chamber.

The configuration of the slots to form a controlled multimodal electromagnetic field may be used in the processing of materials that have short processing times, perhaps taking less than one circulation of the toroidal bed before being removed. By forming a controlled multimodal field with multiple areas of high microwave energy, better control over heating of the material may be achieved. Furthermore, a broad distribution of microwave energy may enable processing of materials that are sensitive to high temperatures. By forming a controlled multimodal field with multiple areas of high microwave energy, the microwave energy is distributed over a larger volume. This means that a greater amount of microwave energy can be input into the apparatus (allowing for a greater amount of material to be processed) without creating a hot spot with an excessively high microwave heating temperature that would damage some material.

FIG. 9 shows an S₁₁ reflection coefficient plot with data 11 for a first embodiment like that shown in FIG. 2 and data 12 for a second embodiment like that shown in FIG. 4. In the plots of FIG. 9, the microwave source is not tuned (in that the system has not been adjusted to optimise coupling with the material in the chamber). An S₁₁ of less than −10 dB is desirable as this represents more than 90% of the input microwave radiation power being absorbed within the chamber. The S₁₁ measurements were taken with a granular material that the apparatus may be used to process placed in the chamber. Tuning of the microwave system can result in greater power transfer efficiency from the microwave generator to the load. The system can be tuned by impedance matching the source and the load using standard industry devices such as a tuner. Efficient coupling (S₁₁ of less than −10 dB) even when the system is untuned is desirable as it reduces the operating requirements of the tuner.

FIG. 9 shows that apparatus according to embodiments is capable of achieving S₁₁ values of less than −10 dB even when untuned, which means that the apparatus can be operated with good efficiency even without calibration. The high efficiency of the apparatus may allow for faster processing times (as more microwave energy can be transferred to the material) or reduced energy consumption. Efficient coupling of the microwave radiation to the chamber may also result in improved reliability and less propensity for arcing due to reduced reflection of microwave radiation Both example systems provide efficient coupling to the material in the chamber.

FIG. 10 shows an S₁₁ plot as in FIG. 9, but now with the apparatus tuned. This figure shows that with calibration very high efficiencies can be achieved, which may be useful for certain applications.

The effects shown in FIGS. 8 to 10 show that the present invention allows for efficient communication of microwave energy to a toroidal bed chamber, with the configuration of the waveguide and wider apparatus generating a well distributed electromagnetic field.

Referring to FIG. 11, circulation fluid inlet may take a number of different forms. The circulation fluid inlet (for introducing circulation fluid with a velocity component tangential to the toroidal volume) may comprise a plurality of vanes or fixed blades 734 that extend radially outwards from the chamber's inner sidewall 711 to the outer sidewall 712. The vanes 734 may be situated in the base of the chamber. The vanes or fixed blades 734 may extend the total distance from the inner sidewall 711 to the outer sidewall 712 such that the majority or the whole base of the chamber comprises the vanes or fixed blades 734.

The vanes or fixed blades 734 may be configured for use in a microwave apparatus. Examples of this include modifying the spacing between the plurality of blades 734 and between each blade and the chamber walls to eliminate dead spaces that may trap material to be processed in the chamber. Material stuck in dead space may become carbonised by the circulation fluid heating or microwave heating, thus becoming an ignition point. The decomposition of trapped material may result in a change in properties that results in arcing from the decomposed trapped material. In addition, the blades 734 and the means of attachment of the blades to the apparatus may be configured to reduce sharp edges that may result in arcing. The blades may be attached to the chamber by an inner and an outer clamping ring, holding the two ends of the blades to the inner sidewall 711 and outer sidewall 712 respectively.

According to an embodiment of the invention, metal components within the toroidal chamber may be fabricated from stainless steel or aluminium, thus reducing arcing caused by airborne dust that may result from rusted surfaces of carbon steel components.

According to other embodiments, the circulation fluid inlet may comprise other forms of inlet in addition to or instead of the plurality of blades 734 at the base of the chamber as described above. The blades 734 may instead be replaced by a plurality of nozzles, jets or other inlet device suitable for high velocity fluid, accomplishing the same functional effect as the blades 734.

According to other embodiments, circulation fluid inlets may be situated in addition to or instead of on the base of the chamber. For example, additional circulation fluid inlets may be situated in the inner sidewall or outer sidewall of the chamber. In an example embodiment of the invention, the inner sidewall 711 may comprise slots or vanes for introducing circulation fluid. By pumping some circulation fluid through these slots or vanes radially outward from the centre of the chamber, a cushion of circulation fluid may be created that directs material away from the inner sidewall. This may prevent material from entering the slots of the waveguide ring situated in the inner sidewall, hence eliminating the need for a microwave transparent window, reducing fabrication cost and increasing the efficiency of microwave energy communication to the chamber. For example, the slots 625 of the waveguide shown in FIG. 7 may dually act as the circulation fluid inlets, with circulation fluid being pumped into the waveguide ring 623 or vertical portion 624 to be introduced to the chamber through the slots 625 in addition to microwave radiation.

Referring to FIGS. 12, according to various embodiments of the invention, the toroidal chamber as discussed in relation to FIGS. 1 to 6 may be formed by chamber walls of varying design and configuration.

An embodiment of the apparatus has a chamber 710a a defined by chamber walls, wherein the outer sidewall 712a is sloped so as to meet the inner sidewall 711a at an angle. In this embodiment the outer sidewall 712a acts as the base of the chamber.

An alternative embodiment of the apparatus has a chamber 710b defined by chamber walls, wherein the inner sidewall 711b is sloped so as to meet the outer sidewall 712b at an angle. In this embodiment the outer sidewall 711b acts as the base of the chamber.

Another alternative embodiment of the apparatus has a chamber 710c defined by chamber walls, wherein there is a base 713c, but this is angled so does not form a horizontal surface. According to embodiments of the invention, the base 713c may be angled upwards from the inner sidewall 711c to the outer sidewall 712c as pictured, or otherwise downwards from the inner sidewall 711c to the outer sidewall 712c.

FIG. 13 shows various examples of material inlets and material outlets that may be used with an apparatus 800 according to the present invention for feeding material to and discharging material from the chamber 810 respectively.

FIG. 13 further illustrates two embodiments of the apparatus with different microwave communication means. The embodiment depicted in the left-hand side of the figure is similar to the apparatus of FIG. 2. The waveguide 820a is situated inside the inner sidewall 811 and comprises a microwave transparent window situated in the inner sidewall 811 above the base 813. The inner sidewall 811 comprises a frustoconical portion 815 in addition to the vertical portion containing the window.

The right-hand side of FIG. 13 shows an embodiment of the apparatus similar to that of FIG. 6. The waveguide 820b is situated below the base 813 with microwave radiation communicated to the chamber 810 through the base 813.

Embodiments may include one or more of the material inlets described with reference to FIG. 13, and may include one or more of the material outlets described with reference to FIG. 13. The toroidal bed chamber 810 of this example apparatus 800 comprises an inner sidewall 811, an outer sidewall 812, a base 813 and a ceiling 814 so as to be completely enclosed.

An example material inlet that may be used according to the example apparatus 800 is a powder injector 860. This inlet feeds material in the form of a fine powder into the chamber 810 by entraining the powder in the circulation fluid. The injector 860 may be situated within or alongside the circulation fluid inlet 830. The injector 860 may also be situated in the toroidal plenum 832 so that material is fed into the chamber 810 with the circulation fluid.

A further example of a material inlet that may be used according to the example apparatus 800 is a side feeder 861. This inlet may be situated in the outer sidewall 812 and feeds material into the chamber 810. The side feeder 861 may comprise a screw auger used to push material into the chamber 810.

A further example of a material inlet that may be used according to the example apparatus 800 is a single top feeder 862. The single top feeder 862 may be situated in the ceiling 814 of the chamber 810 and allows material to be dropped or fed in via gravity. The single top feeder 862 may also comprise a screw auger.

A further example of a material inlet that may be used according to the example apparatus 800 is a central top feeder 863. The central top feeder 863 may be situated in the ceiling 814 of the chamber 810 and feeds material onto the conical portion of the inner sidewall 811. This creates a more even distribution of material around the toroidal chamber 810 which may be advantageous for some materials. As with the top feeder 862, the central feeder 863 may be gravity driven or comprise a screw auger. The central top feeder may be co-axial with the toroidal bed chamber.

An example of a material outlet that may be used according to the example apparatus 800 is a bed diverter discharger 870. The bed diverter discharger 870 outputs material from inside the toroidal bed of material by diverting material from the bed as it circulates. The bed diverter discharger may comprise a diverter that diverts the flow of the circulating material towards a longitudinal axis of the toroidal bed chamber. As more material is added to the chamber 810, the level of the bed will gradually rise up the toroidal bed volume 840 until it reaches the diverter of the bed diverter discharger 870, meaning that material is continuously discharged as new unprocessed material is added. Materials that become less dense (e.g. during drying processes) will naturally be moved to the bed diverter discharger 870 at the inner sidewall 811 as unprocessed, more dense material is flung to the outer sidewall 812 by the centrifugal force of the circulating bed.

A further example of a material outlet that may be used according to the example apparatus 800 is a lifting chamber discharger 871. The lifting chamber discharger 871 may be situated on the outer sidewall 812 and configured to be at a height adjacent to the toroidal bed volume 840. The lifting chamber discharger 871 is configured so that a part or all of the outer sidewall 812 may be lifted, creating a circumferential gap in the outer sidewall 812. The circulating material is then rapidly discharged through the gap under centrifugal force. The lifting chamber discharger may be operable to lift the outer sidewall to create the circumferential gap.

A further example of a material outlet that may be used according to the example apparatus 800 is a side discharger 872. This outlet may be situated on the outer sidewall 812 above the operating level of the toroidal bed volume 840 so that material exits the toroidal bed chamber 810 entrained in a flow of gas. This may be advantageous for materials that puff as they are processed, as the puffed material can be easily discharged in this manner from the upper regions of the chamber 810. The side discharger 872 may comprise a flow controller (such as a valve) to control the flow of gas (and entrained material) through the side discharger 872. The inlet of the circulation fluid to the chamber 810 may also be controlled to control the flow of gas (and entrained material) exiting the chamber. The side discharger 872 may comprise a diverter to divert a flow of circulating material to exit the toroidal bed chamber 810. The side discharger may comprise an actuator configured to move the side discharger diverter into and out of the flow of circulating material.

A further example of a material outlet that may be used according to the example apparatus 800 is a dump door 873. The dump door 873 may be situated in the outer sidewall and may be a substantial fraction of the chamber's 810 height. The dump door 873 can be opened to discharge material rapidly (the whole contents of the chamber will egress rapidly when the dump door 873 is opened).

The example apparatus 800 may use other material outlets that rely on suction to extract material from the chamber 810. The apparatus 800 may comprise a pneumatic or vacuum extractor comprising an extraction pipe that can be lowered in from the ceiling 814 (for example by opening a lid or other opening in the ceiling 814) or through an opening in the outer sidewall 812.

In addition to material outlets there may be exhausts for the circulation fluid. The circulation fluid exhausts may be situated in the ceiling 814 so that circulation fluid flows up from the base 813, passing through the bed before exiting the chamber.

These are not limiting examples of material inlets and materials outlets that may be used with the apparatus of the present invention. It is understood that a plurality and/or an assortment of material inlets and outlets may be used to suit the processing requirements of specific materials.

FIG. 13 further illustrates an advantage of feeding microwaves into the chamber via a waveguide that extends upward from below the chamber. In certain embodiments, the toroidal waveguide portion 823 and vertical waveguide portion 824 can be situated inside the centre portion of the apparatus 800, where they do not interfere with any of the material inlet or outlet devices.

In addition to inlets and outlets for material, some embodiments of the apparatus may comprise a circulation fluid exhaust 882 for extracting circulation fluid from the chamber 810 after it has passed through the material bed.

FIG. 14 shows a schematic diagram of an apparatus 900 according to an embodiment and further describes the generation and treatment of the circulation fluid outside of the main body of the toroidal bed chamber 910. The circulation fluid may be a hot gas.

The apparatus 900 of this example embodiment comprises a fan or impellor 980 that accelerates the circulation fluid. The circulation fluid may be accelerated to a sufficient speed prior to entering the chamber 910 such that it is capable of creating a circulating fluidised bed of material as per the operating requirements of a TORBED apparatus. Circulation fluid may be supplied to the apparatus 900 by a source of fresh air, such as an intake of the fan 980.

The apparatus 900 may further comprise a heating device 981 that is capable of heating the circulation fluid. The circulation fluid may be heated to a sufficient temperature prior to entering the chamber 910 such that it is capable of the heating the material sufficiently as per the processing requirements of the material. In some embodiments the heating may be entirely by microwave heating, and the circulating fluid may only be heated by contact with the material in the chamber (indirect heating by the microwaves).

The heating device 981 may also be operable to cool the circulation fluid. Cooled circulation may be provided to the chamber 910 to prevent the material being overheated as microwave radiation is applied.

Heating or cooling of the fluid may allow for the temperature profile across any given particle in the material to be controlled (along with the duration of heating and/or cooling applied to the particle). For example, high power microwave radiation may be applied to the material to thoroughly and quickly heat the interior of material particles, while cold circulation fluid is used to cool the surface of material particles, removing thermal energy from the material and preventing burning.

The fan 980 and heater 981 may have controls that enable a user to adjust the speed and temperature of the air, allowing for processing of a wider range of materials.

The toroidal bed chamber 910 may comprise an exhaust 982 configured to extract circulation fluid from the chamber 910. The exhaust may comprise a filter so that no material is blown from the chamber 910 along with the circulation fluid, reducing the likelihood of damage to the fan 980 or heater 981.

The apparatus 900 may comprise a circulation loop 983 such that the output of the exhaust 982 is fluidly coupled to the intake of fan 980. In this embodiment the circulation fluid may be cycled multiple times through the apparatus 900, retaining some of its heat and therefore reducing the energy consumption needed to heat or cool the circulation fluid.

Some of the circulation fluid passing through the apparatus 900 may be extracted from the circulation loop 983 or elsewhere on the apparatus. The extraction may simply be an outlet whereby a portion of the fluid is vented. The circulation loop 983 may contain further devices for the regulation of the circulation fluid, for example a dehumidifier. In such an embodiment the dehumidifier would extract excess moisture from the circulation fluid after exiting the exhaust 982, thereby keeping the humidity of the circulation fluid within a desired range as the material is processed. This is important for processes where the material is being dried.

Although example embodiments have been described, these are not intended to limit the scope of the invention, which should be determined with reference to the accompanying claims.

1. Apparatus for processing a material, the apparatus comprising:
a toroidal bed chamber, comprising:
chamber walls comprising an inner sidewall, an outer sidewall and a base, the inner sidewall, outer sidewall and base at least partly defining a toroidal volume for material to circulate within;
a circulation fluid inlet for introducing a circulation fluid with a velocity component tangential to the toroidal volume for causing the material to circulate within the toroidal volume;
a waveguide for receiving microwave radiation and communicating the microwave radiation to interior of the toroidal bed chamber, the waveguide comprising at least one microwave transparent window in the inner sidewall, the outer sidewall or the base.

2. The apparatus of claim 1, wherein the waveguide further comprises a vertical portion that extends upwards towards the microwave transparent window from below the toroidal bed chamber.

3. The apparatus of claim 1 or claim 2, wherein the waveguide comprises a waveguide ring that is situated adjacent to the inner sidewall, the outer sidewall or base of the chamber, and wherein the waveguide ring comprises at least one slot for communicating the microwave radiation to the chamber.

4. The apparatus of claim 3, wherein the waveguide ring comprises a plurality of slots that are evenly or unevenly spaced around the waveguide ring.

5. The apparatus of claim 3 or claim 4, wherein the at least one slot of the waveguide ring is configured so that the microwave radiation carried to the chamber via the slots from the waveguide drives a multimodal electromagnetic field within the chamber.

6. The apparatus of any preceding claim, wherein the toroidal bed chamber further comprises at least one inlet for introducing the material into the chamber.

7. The apparatus of claim 6, wherein the at least one inlet for introducing the material to the chamber comprises at least one of:
a powder injector configured to entrain powder in the circulation fluid before the circulation fluid inlet;
a side feeder configured to introduce material via an opening in the outer sidewall of the toroidal bed chamber;
a top feeder configured to introduce material from the top of the toroidal bed chamber.

8. The apparatus of any preceding claim, wherein the toroidal bed chamber further comprises at least one outlet for removing the material from the chamber.

9. The apparatus of claim 8, wherein the at least one outlet for removing the material from the chamber comprises at least one of:
a bed diverter discharger configured to divert a continuous flow of the circulating material to exit the toroidal bed chamber;
a lifting chamber discharger configured to open a circumferential gap in the outer sidewall of the toroidal bed chamber so that circulating material escapes the chamber under centrifugal force;
a side discharger configured to discharge circulating material through the outer sidewall;
a dump door arranged in the outer sidewall;
a pneumatic or vacuum extractor configured to remove material from the chamber using suction.

10. The apparatus of any preceding claim, further comprising a microwave radiation source, wherein the microwave radiation source is coupled to the waveguide.

11. The apparatus of any preceding claim wherein the circulation fluid is gas.

12. The apparatus of any preceding claim, wherein the apparatus further comprises a heating device for heating or cooling the circulation fluid.

13. The apparatus of claim 12, further comprising a controller configured to control a temperature of the circulation fluid and a microwave heating power.

14. The apparatus of any preceding claim, wherein the apparatus further comprises a fan or an impellor for accelerating the circulation fluid prior to entering the chamber.

15. The apparatus of claim 14, wherein the apparatus further comprises a circulation fluid loop that fluidly couples a circulation fluid exhaust of the chamber to the fan or impellor.

16. A method for processing material, comprising:
circulating material within a toroidal chamber using a flow of fluid with a velocity component tangential to a toroidal chamber;
heating the material as it circulates within the toroidal chamber by introducing microwaves to the toroidal chamber through a microwave transparent window in an inner sidewall, outer sidewall or base of chamber walls that at least partially define the toroidal chamber.

17. The method of claim 16, wherein the microwaves are supplied by a microwave radiation source situated below the toroidal chamber via a vertical waveguide.

18. The method of claim 16 or claim 17, further comprising using the microwaves introduced to the toroidal chamber to generate a multimodal electromagnetic field.

19. The method of any of claim 16 to claim 18, further comprising:
introducing material into the chamber via a material inlet; and
at a time after introducing material, removing material from the chamber via a material outlet.

20. The method of any of claim 16 to claim 19, further comprising:
heating or cooling the fluid prior to the fluid entering the chamber;
heating or cooling the material as it circulates by the transfer of heat from the heated fluid to the material or from the material to the cooled fluid.

21. The method of any of claims 16 to 19, further comprising:
cooling the material as it circulates by the transfer of heat from the material to the circulating fluid.

22. The method of any of claim 16 to claim 21, further comprising accelerating the fluid prior to the fluid entering the chamber.

23. The method of any of claim 16 to claim 22, further comprising recycling the fluid exiting the toroidal chamber back into the toroidal chamber again to circulate material.

24. The method of claim 20, further comprising controlling the heating or cooling of the fluid and the introduction of microwaves to the chamber to regulate the heating of the material.
